(19) United States
(12) Patent Application Publication
(10) Pub. No.: US 2014/0261150 A1
(43) Pub. Date: Sep. 18, 2014

(54) Adjustable and Portable Ribbon Bookmark

(71) Applicant: Virtual Development Corporation, Bangor, ME (US)

(72) Inventors: Gary Robinson, Bangor, ME (US); Deborah Hoffert, Bangor, ME (US)

(73) Assignee: Virtual Development Corporation, Bangor, ME (US)

(21) Appl. No.: 14/218,875

(22) Filed: Mar. 18, 2014

Related U.S. Application Data
(60) Provisional application No. 61/925,569, filed on Jan. 9, 2014.
(60) Provisional application No. 61/800,664, filed on Mar. 15, 2013.

(51) Int. Cl. B42D 9/00

(52) U.S. Cl. CPC B42D 9/004
USPC 116/201; 116/234

(57) ABSTRACT

This bookmark comprises a flat anchor and a ribbon. The anchor has non-aggressive pressure-sensitive adhesive on its back, to enable it to adhere to a book surface such as the inside back cover. The adhesive is weak enough that the bookmark may be detached and used in another book without leaving significant residue. The ribbon is attached to the anchor so that it the user can slide it to lengthen or shorten the upper part of the ribbon. The user drapes the upper part of the ribbon over the tops of the desired pages and back down into the book to mark a particular page. The user may adjust the length of the ribbon so that it slightly protrudes from the bottom of the book. The anchor may contain graphic images or text.

### CROSS-REFERENCE TO RELATED APPLICATIONS

This non-provisional application claims the benefit of the priority date of U.S. provisional application 61/800,664, filed Mar. 15, 2013, and also claims the benefit of the priority date of U.S. provisional application 61/925,569, filed Jan. 9, 2014.

### TECHNICAL FIELD

This application concerns stationery products, specifically bookmarks.

### BACKGROUND OF THE INVENTION

Bookmarks are very useful devices, but the traditional flat bookmark, made to be placed between the pages the user wants to mark, has disadvantages. When a user picks up a book to read, which has a bookmark in it, she has to find a place to put the bookmark while she's reading. If she puts it in unread pages of the book being read, it has a tendency to fall out. In any case, it often gets lost.

Some books, most notably many Bibles, have built-in ribbon bookmarks for marking a page. These are very convenient. They're always there, they don't get lost, and they're easy to use.

But few books come with built-in bookmarks. So, for readers who appreciate ribbon bookmarks, there is clearly a need for a ribbon-style bookmark that can be acquired separately and added to books.

### BRIEF DESCRIPTION OF THE INVENTION

The present invention is a new kind of bookmark. This bookmark attaches the ribbon to an anchor in such a way that the ribbon is moveable in a vertical direction (that is, parallel, or close to parallel, to the spine of the book). Preferred embodiments accomplish this by having the ribbon run between two slits in the anchor, each close to the left hand side of the anchor and perpendicular to the book spine. In those preferred embodiments, the anchor is intended to be placed in the upper left-hand corner of the inside back cover of a book.

The anchor is flexible (made of paper or some other flexible material) and has a non-aggressive adhesive on one side such that it can be attached to a page or cover of a book, and be moved to other books if desired. As mentioned above, the preferred mode of use is to place the anchor against the inside back cover of a book, in the upper left-hand corner of that cover. Not only is an inside placement less likely to fall off because of being disturbed by rubbing against some other object, but also, every time the book is closed, the anchor is pressed against the surface it's attached to, reinforcing the bond. And it does not disturb the look and feel of the outside of the book.

An example of an existing article of manufacture that can be used for the anchor is a 3M Post-it note, preferably the “full adhesive” type where one side is completely covered by adhesive except for the area near one edge, which is adhesive-free in order to facilitate easy removal by lifting at that edge.

In the preferred embodiment, two slits are cut into the anchor, such that a ribbon can be run through it.

Since the ribbon is partly under the anchor and partly above it, the adhesive could interfere with movement of the ribbon. One or more pieces of single-sided adhesive tape are placed in such areas, with the tape adhesive joined to the Post-it adhesive, such that the tape separates the ribbon from the Post-it adhesive. Thus the ribbon can flow freely.

In the preferred embodiment, the user places the anchor against the upper left-hand side of the inside back cover of the book. Since the ribbon is positioned through the slits on the left side of the anchor, the ribbon is near the spine of the book. The user can pull the ribbon through the anchor so that the portion that is used to mark pages is the desired length. It is expected that most users will want the ribbon through the marked pages and protrude a bit past the bottom of the book. Setting this up at the start of reading a new book can be an enjoyable part of the user's new-book experience.

And in preferred embodiments the anchor enough contains space for graphic designs to be displayed that are attractive and/or useful. For example, there is a very long history of people using “bookplates” to indicate book ownership. These are usually paper sheets, a few inches in width and height, with permanent adhesive on the back, which contain a space for the owner to write (at least) his name. Often, bookplates have very attractive, artistic designs—in fact there is at least one web site devoted to the latest developments in bookplate graphic design. In preferred embodiments, the anchors used in the present invention have those characteristics.

One unique opportunity for fun with graphic design is to print on the anchor the image of an animal with a long tongue, such as an aardvark. (Or, equivalently, an animal with a long tail.) The animal's tongue can be printed so that it extends to the slit nearest the top of the book, so that it appears that the tongue extends right onto the ribbon. The ribbon is printed with a line in the matching position, that extends for a substantial portion (or all) of the ribbon's length. In this manner, it appears that the animal has an extremely long tongue that gets longer as one pulls the ribbon to find the best length for the present book.

A key aspect of the present invention is the way it addresses the following facts:
1) Books are not all the same size.
2) Marketing and purchasing of bookmarks will be more convenient and economic if users don't have to guess the right size for each book, and if store displays don't have to make many different sizes available.
3) Bookmarks should be reusable in books of different size (as is the case with traditional, flat bookmarks).
4) Book ribbons are traditionally designed to go into the top of a book and protrude a bit (often around ½ inch) from the bottom. This is a pleasant approach. The user can see at a glance, even when the book is lying on a table with only the bottom viewable, that the book has a ribbon and that it's marking a page. The length conveniently allows a user to remove the ribbon from between the pages, or to place it there, while not protruding in an ungainly way.

The present invention improves on bookmarks such as the one found at the following web address: http://www.instructables.com/id/Ribbon-Markers-for-a-Reference-Book/ (retrieved on Mar. 13, 2014). The linked bookmark affixes ribbons in an immovable way to a plastic anchor which is placed into the spine of a book. It can only readily be pushed to one unobtrusive position, where the top of the anchor is even with the top of the spine. The bookmarks have a fixed length. If it were to be moved to a different book requiring different lengths, the bookmark would have to be inconveniently reconfigured, possibly with new ribbons.

One possible solution to this problem is the following. With a simple ribbon of predetermined length, one can adjust how much the ribbon protrudes from the bottom of the book by changing the placement of the anchor, if the anchor is of a type that can be placed in multiple book locations. This is true of patent application DE4125234 A1, and patent U.S. Pat. No. 5,439,254. The ribbon extends from the anchor to the top of the book, and then down between the pages that are being marked. So, if the anchor is moved toward the bottom of the book, the part protruding from between the pages must go up. If it protrudes too much, move the anchor down; if it doesn't protrude, or protrudes too little, move the anchor up.

However, there is a subtle problem with that approach, which the present invention addresses, while also adding an element of fun. The following few paragraphs describe that problem.

When the user is reading the book, the anchor is attached near the bottom of the book, the ribbon may be in one of two states:
1) Dangling freely down.
2) Looped over the top of the book. For instance, if the anchor is attached to the inside back cover, the ribbon would normally be looped over that back cover so that the non-anchor end, and the portion of the ribbon near it, are outside the book. And, normally, since the anchor is preferably placed near the spine, the ribbon outside the book is also near the spine, where it's as out-of-the-way as possible.

Dangling freely down is ungainly and unattractive. People don't tend to use it that way. Looping over the top is better.

However, if the anchor is near the bottom of the cover, there is almost as much ribbon on the inside of the book going up as there is on the outside going down, interfering with the tendency of gravity to keep the ribbon somewhat taut inside the cover, so that the ribbon remains straight and attractive instead of bunching up.

Also, to the degree that the ribbon is unconstrained from lateral swing in the portion between the anchor and the top of the book, the ribbon will again tend to move out of its straight and attractive positioning near the spine, and has a significantly greater possibility of falling off the back cover entirely.

Enjoyment of a bookmark is largely determined by a combination of ease of use and aesthetics. Bookmarks that try to solve practical problems such as denoting the exact line the user stopped reading haven't been successful in the marketplace, because, even though they solve a problem, they tend to require more effort of the user, lowering the ease of use. Rather, winners in the marketplace have tended to improve the aesthetic experience (such as by placing 3D images on the bookmark) without making any new demands of the user.

The present invention actually improves ease-of-use, by eliminating the possibility of the bookmark falling out of the book, and by eliminating the need to remove the bookmark while reading, and to find and place it back in the book again when done. And it does this while avoiding the ungainly, inconvenient aspects of other ideas inventors have tried, while offering a potential aesthetic experience at least as good as traditional bookmarks—it can take advantage of technologies like 3D images while adding the fun of an image that appears to elongate as the ribbon is pulled up.

Thus, unlike earlier attempts to make a better bookmark such as those described above, the present invention has characteristics necessary to potentially make a major impact on the market.

### BRIEF DESCRIPTION OF THE DRAWINGS

FIG. 1 is an elevation view of the front of the preferred embodiment of the invention, including an anchor with a slit-based ribbon guide, and graphics (including text). It also shows the ribbon.

FIG. 2 is an elevation view of the side of a folded-back ribbon stop.

FIG. 3 is an elevation view of the back side of the anchor from FIG. 1, without the ribbon, showing where tape is placed to separate the ribbon from the anchor's adhesive.

FIG. 4 is an elevation view of the front side of another embodiment of the invention, showing an anchor which includes a tunnel-based ribbon guide.

FIG. 5 is an elevation view of the back side of an alternative embodiment of the invention, showing that the back of the anchor has no adhesive in the area where the ribbon would otherwise be in contact with it, eliminating the need for a separating layer such as tape. Additionally, it has a protruding adhesive-free tab that can be used to lift the anchor.

FIG. 6 is a perspective view of an embodiment of the bookmark being used to mark a page before the book is closed.

### DETAILED DESCRIPTION OF THE INVENTION

The drawings referred to herein are for the purpose of illustrating the various aspects of the present invention and are not meant to limit its scope.

Referring now to the embodiment depicted in FIG. 1, which is the preferred embodiment, anchor 1 is a flat, flexible material such as paper, with a weak (i.e. non-permanent) adhesive almost covering one side. For manufacturing simplicity, this embodiment makes use of Post-it Super Sticky Full Adhesive Notes, 3×3 inches for anchor 1. This type of Post-it note has an area ¼ inch wide, located at the note edge that lies between the two rounded corners, which has no adhesive. (Note: the scaling of this figure, and other figures, is not intended to be exact.)

The adhesive is used to bond the anchor to a book cover or page. Pressure-sensitive adhesives such as those used in 3M's Post-it notes products are ideal, as they are formulated to allow notes to be removed from a surface without leaving residue and without damaging the surface, and subsequently used again on another surface. In particular, preferred embodiments equal or approximate the degree of adhesiveness used in 3M's Super Sticky Post-it notes. The adhesive may or may not cover the entire back of the anchor, consistent with the needs of the embodiment.

The embodiment of FIG. 1 is configured so that its optimal placement is the upper left-hand corner of the inside back cover of the book, which, due to the flexible nature of the anchor material, does not have to be hardbound, but rather can also be paperback. For the convenience of the user, the adhesive-free area is on the edge of the anchor that is farthest from the spine.

A ribbon 3 is attached to anchor 1 by two slits 2 configured so that the ribbon can be pulled toward the top or bottom of the book. While the ribbon can be any of numerous materials, the preferred embodiment uses a type of ribbon that is used in existing built-in ribbon bookmarks, such as in Bibles. The ribbon can be used to mark the position in the book. To do this, the user drapes the ribbon over the top of the book and between two pages, of which one is the last one she was reading.

The reader will often want the ribbon to protrude a bit from the bottom of the book, and in that case she pulls the ribbon up toward the top of the book from the anchor to extend the bookmarking portion, or down toward the bottom to make it shorter.

The ribbon has a length configured to be approximately twice the height of a book that is relatively small with respect to a target market. For example, textbooks tend to be larger than novels. So embodiments targeted to the textbook market will include a ribbon whose length is twice that of the height of a relatively small textbook. In the preferred embodiment, the ribbon is more twice as long as the height of about 20% of textbooks, and less than twice as long as the height of about 80% of textbooks. Other lengths may be chosen as necessary.

The preferred embodiment shown in FIG. 1 has two slits 2 cut into the anchor, through which the ribbon can travel, forming a ribbon guide. Its direction of travel is dictated by the alignment of the two slits. When the anchor is attached to a book in its proper orientation, each slit is perpendicular to the spine of the book. And, were a line to be drawn from the middle of one slit to the middle of the other, that line would be parallel to the spine of the book. The slits are slightly wider than the ribbon, so that it can flow fairly easily through them, but with enough resistance that it does not tend to change its position with respect to the anchor except when pulled by the user. The slits, configured in this manner, comprise a properly-configured ribbon guide.

The ribbon is folded over 4 and glued at the end toward the bottom of the book, forming a ribbon stop, so that it is unlikely to be inadvertently get pulled so far by the user that it no longer runs through bottom slot (and, if pulled even father, the top) slot.

In FIG. 2, the folded-over ribbon stop portion 14 of the ribbon 3 is held in that position by glue 15. In preferred embodiments, the glue is a strong, permanent glue suitable for the material used in the bookmark.

FIG. 3 shows the back of a the anchor in FIG. 1. The anchor has an adhesive-covered area 33 and a non-adhesive-covered area 32. The latter is ¼ inch wide and is between the two rounded corners. Note that the portion of the anchor that is hidden by piece of tape 31, which is placed between the slits, is also covered with adhesive. When configured for use, the ribbon goes through the slits in such a way that the tape lies between the anchor's adhesive and the ribbon. In this preferred embodiment the tape is standard adhesive tape, such as 3M's Scotch Magic Tape, positioned with the adhesive of the tape facing the adhesive of the anchor. This provides an excellent bond; moreover, this tape is inexpensive, commonly available, and is an appropriate width to separate reasonably-wide ribbons from the anchor adhesive.

In FIG. 4 we have a ribbon guide part of anchor 40, which is based on creating a ribbon-guiding tunnel for the ribbon to run through. Ribbon cover 41, which can be paper or another flexible material, is attached to the bookmark in such a manner that the ribbon can essentially only be pulled in an up or down direction—not away from the book or laterally. In the figure, the sides of covering are glued 42 to the anchor, forming a ribbon-guiding tunnel, and ribbon 3 is run through that tunnel. In these embodiments, the ribbon cover is attached to the top of the anchor, but it may be attached to the bottom if the there is no adhesive where the ribbon touches the anchor, or if a separating material such as tape is supplied.

An alternative embodiment to the mechanism in FIG. 4 is to fold the anchor material over part way, so that a ribbon-guiding tunnel is formed that is structurally identical to the tunnel of FIG. 4 while only requiring one piece of material, which only needs to be glued on one side of the tunnel. Other embodiments involve more than one ribbon-guiding tunnel, placed with respect to each other so that the ribbon movement is directed the same way as it is with just one ribbon-guiding tunnel (as long as the ribbon is taut enough that it doesn't bunch up between the ribbon-guiding tunnels).

Glues used in forming ribbon-guiding tunnels are typically not the weak, pressure-sensitive glue used for anchors. The glue should be strong; its pressure-sensitivity is not important. Rubber cement is one appropriate glue.

When slits are used, it is usually the case that making the slits slightly wider than the ribbon, and covering as much of the back of the anchor with adhesive as possible (while separating the ribbon from the adhesive, and preferably leaving a small portion of the anchor adhesive-free), creates a situation where there is an amount of friction that is close to ideal. It is easy for the user to pull the ribbon when she wants to change the length while the anchor is attached to a cover or page, but the ribbon rarely or never moves without being purposefully pulled by the user.

This is harder to achieve with ribbon-guiding-tunnel-based embodiments. In such embodiments the tunnel has to be designed so that there is enough friction with the ribbon. The tunnel tops have to push the ribbon into the anchor. Or, in embodiments where there is a cutaway in the anchor such that the ribbon touches the book cover or page, the ribbon must be pushed against that. Those skilled in the art will readily see how to provide the necessary pressure through tautness of the tunnel materials. But the fact that this issue is virtually automatically solved with the slit-based embodiment is one reason that is the preferred embodiment.

FIG. 5 shows the back side of the anchor of another embodiment, wherein there is no adhesive 51 in two areas: between the slits 2 and on a protruding tab 52. The adhesive-free tab, like the adhesive-free edge in FIG. 3, makes it easy to lift the anchor away from the book so that it can be used with another book. (This embodiment is configured such that the ribbon runs against the back side of the anchor when it is between the slits.)

FIG. 6 shows the anchor 63 and ribbon 3 in use in a book 62. The ribbon is behind the anchor above the upper slit and below the bottom slit instead of between them. The bookmark is anchored to the upper left-hand corner of inside back cover 61. The user has manually draped ribbon 3 over a portion of the pages of the book 62.

Since ribbon ends typically fray, preferred embodiments include aspects for stopping fraying. The preferred embodiment uses a synthetic ribbon, such as nylon, and heat to cause the threads to run together to stop fraying. In conjunction with a folded-back ribbon stop, heat to stop fraying is preferably applied before the folding operation is undertaken.

The bookmark of the present invention can be manufactured in many ways that will be readily apparent to those skilled in the art. Once manufactured, and acquired by the user, the user takes the step of opening the book to the location where he desires to place the bookmark. In the preferred embodiment, the anchor is configured so that the ribbon is attached to the left side of the anchor when the anchor is oriented so that the ribbon is vertical, and the user affixes the anchor to the upper left of the inside back cover. In the preferred use she applies some pressure to activate the pressure-sensitive adhesive; in other use, pressure is applied as a side-effect of closing the book.

For further description of certain embodiments, provisional patent applications 61/800,664 and 61/925,569 are hereby incorporated by reference.

### Glossary

Anchor: A flexible, flat material (paper in the preferred embodiment) with a weak adhesive on one side, for use in attaching the anchor to a book cover or page.
Anchor Back (“back of the anchor”, etc.): The side of the anchor that has weak adhesive for the purpose of attaching the anchor non-permanently to a book page or cover.
Anchor Front: The opposite side from the back.
Anchor Top: When the anchor is in use in a book, the edge closest to the top of the book.
Anchor Bottom: When the anchor is in use in a book, the edge closest to the bottom of the book.
Anchor Base Part: The flexible, flat material that attaches to a page or book cover in embodiments where more members than the anchor itself are used in forming an anchor guide. It may or may not have holes in it. The side of it that attaches to the page or book cover has pressure-sensitive adhesive.
Book Top: When the reader is holding a book for reading in typical use, the top comprises the furthest-from-the-floor edges of the covers and pages.
Book Bottom: The opposite of the top.
Upper: The portion of the item under discussion that is nearer to the book top. With respect to the ribbon, the upper portion is the portion extruding from the upper end of the ribbon guide.
Lower: The portion of the item under discussion that is nearer to the book bottom. With respect to the ribbon, the lower portion is the portion extruding from the lower end of the ribbon guide.
Up: Toward the book top.
Down: Toward the book bottom.
Vertical: Parallel to the spine of the book. Up-and-down if the book is standing upright on its bottom.
Horizontal: Perpendicular to vertical.
Ribbon Stop: A portion of the ribbon or attachment to it, intended to make it difficult for the user to inadvertently pull the ribbon so far through the ribbon guide that the ribbon no longer protrudes from the guide at one or both ends.
Ribbon Guide: The mechanism that, in normal use, holds the ribbon to the anchor in a vertical orientation and prohibits movement in a horizontal direction or at an angle to the vertical, while allowing it to slide in a vertical direction. In other words, it allows movement essentially only parallel to the spine of a book when said anchor is in normal use. It also provides a degree of resistance to movement such that a user can easily pull it in along the vertical axis, but such that it will rarely, if ever, move without being pulled.
Ribbon-Guiding Tunnel (also referred to as “tunnel” for short): An alternative to slits for forming a ribbon guide. The ribbon is partially enclosed by one or more members organized such that a ribbon guide is formed.
Separating Material: Separates the ribbon from the anchor adhesive, so that the ribbon may slide freely in vertical directions in embodiments where otherwise, the anchor adhesive would be in contact with the ribbon.
Inside Back Cover: The side of the back cover of a book that faces the book's pages when the book is closed.
Non-Aggressive Pressure-Sensitive Adhesive: A pressure-sensitive adhesive such that the adhering item can be easily removed from the adhered-to surface and subsequently users to adhere to a different surface, essentially without leaving residue behind. The adhesive used for 3M's Post-it Super Sticky Full Adhesive Notes is an excellent example.

### Alternative Embodiments

Instead of making the anchor of paper, other flat materials that are thin and flexible may be used. Examples include flexible plastic sheets, cloth, aluminum foil and DuPont's Tyvek.

The anchor can have any desired shape as long it is flat and fits within the book. For example, if the anchor is to be printed with the image of an animal, it could be shaped like that kind of animal. It can have cut-out areas.

The ribbon may be made of any material that is traditionally used for ribbons. Synthetic materials such as nylon or polyester, or silk, cloth, or any other natural material that may be fashioned for use as a ribbon may be used.

Ribbons may be of any length in a range of reasonable lengths that is determined by the target market. A ribbon is out of that range if, with the upper and lower portions of the ribbon laid out such that the lower portion is laid straight down from the ribbon guide and the upper portion is laid so that it runs up to the top of the book and draped over the back half of the book's pages, and furthermore runs down over the first of the back half of the book's pages, then there is no way of adjusting it so that it protrudes about ½ inch below that page.

Any pressure-sensitive adhesive which has the appropriate degree of adhesiveness (in the range of adhesives used on 3M Post-it notes; this will imply removability) and the ability to not leave significant residue can be used. One example is SmartAdhesives P1 Removable PermaTack.

Some embodiments may have pressure-sensitive adhesive on both sides of the anchor if, for example, it is desired to be able to temporarily attach something to the front of the anchor. Permanent adhesive could also be used on the anchor front to, for instance, attach a personal photo to the anchor.

Decorative items such as picture holders, metallic stars, and anything else that doesn't have a shape or weight that substantially hinders the functionality of the invention as a bookmark can be added to either the ribbon or anchor. Functional embellishments can also be added, such as the adhesive dot taught in U.S. Pat. No. 5,515,809 or the sliding tab taught in U.S. Pat. No. 6,205,947.

There are many ways to attach the anchor such that it can be moved in a vertical direction when the anchor is placed a book, while restricting its movement in other directions. The figures contain examples. Some slit-based embodiments may have more than two slits. Tunnel-based embodiments may have more than one tunnel and if there are multiple tunnels, the tunnels can be so “short” that they are actually loops of string or thread rather than a flat material. When multiple tunnels (or more than two slits) are used in the guiding of a single ribbon, they together comprise the ribbon guide for that ribbon.

Tunnel-based embodiments can attach the tunnel using other means than glue or folding. Other examples include staples, and cutting tabs on the edges of the tunnel covering material which may be inserted into slits cut into the anchor for that purpose. Such tabs may be specially glued in place, or rely on the anchor's adhesive. One or more folds may be used.

Various embodiments may or may not contain graphics which may or may not contain animals, and the ribbon may or may not contain graphics. Graphics may connect the image on the anchor to artwork on the ribbon (as with the aardvark image in FIG. 1), or not.

While preferred embodiments the graphics will include text such as “This book belongs to” or “ex libris” and a line for the user to write his name, other embodiments may have space for more or less such information, or none. Embodiments can have text for any purpose a manufacturer or user wishes, such as a list of conversion measures for a cookbook or electrical formulas for an engineering book, or a list of pages where various characters are first mentioned for a novel.

Ribbon stops may include a folded-back and glued portion of ribbon, or folded-over with the folded-over portion attached to the main portion by means of glue, glue dots, heating, staples or other methods. In preferred embodiments the folded-over portion is approximately ⅓ inch, but this can vary. The ribbon may be folded back, or folded at an angle. Additional mechanisms that may be used instead of folding include attaching an object to the ribbon that is too wide to fit through either end of the ribbon guide. Practitioners of the related arts and crafts will readily see how to attach metal, plastic, cardboard, or other objects, typically flat, that accomplish the stopping purpose to a useful degree, and which would not be too large or heavy to work with the bookmark.

Glues used in making the ribbon stop are stronger adhesives than used for attaching the anchor to the book, and do not need to be pressure-sensitive. Glue dots, epoxy, contact cement, E-6000, and cyan-acrylate glue are examples.

Ribbon stops may be used on either or both ends of the ribbon, although preferred embodiments have them only at the end that is associated with the lower part of the ribbon.

Some embodiments have multiple ribbons, running through the same or different ribbon guides.

Ribbons may include graphics which may include text for any purpose.

Anti-fraying can be achieved by a large number of ways. Heating has been mentioned above. It can also be accomplished by painting the ribbon ends with clear nail polish, or applying glue such as a cyan-acrylate glue. There are also products made specifically for this purpose, such as Stop Fray and Fray Check. Other techniques are well-known in the art of working with ribbons, and may be referenced at many web sites such as https://www.theribbonretreat.com/custom/modules/FreeProjects/PDFSealingRibbonEnds.pdf, http://store.scrapbook.com/fc-10574.html, http://www.weddingcrafter.co.uk/tips-and-techniques/10/your-questions-answered/51/how-do-i-stop-ribbon-from-fraying. (Retrieved on Mar. 13, 2014.)

Tunnel materials can be the same or different from the anchor, and include similar choices of materials.

Glue used in forming tunnels can be any strong glue which is appropriate for the materials being used to form the tunnels. Rubber cement, glue sticks such as Uhu and Tombo, white glues such as Delta Sobo or Talas Jade PVA, and other glues can be used.

Where there is the potential for the ribbon to get stuck in the adhesive on the back of the anchor, the figures show using tape, such as a pressure-sensitive adhesive tape with its adhesive facing the anchor adhesive, as a separating material. This can be accomplished in a number of other ways, including using a length of paper, foil, or ribbon, or coating the anchor in that area with substance such as non-pressure-sensitive adhesive, such as an air-drying one, which, after drying, would provide a coating separating the ribbon from the anchor adhesive. While the figures show the ribbon positioned vertically, on the left side of the anchor, it could be positioned vertically, toward the center or on the right side. The left side is most appropriate when, in the expected use, the left side of the anchor would be near the book spine, such as when the anchor is to be placed on the inside back cover. Similarly, the right side is most appropriate when it is expected that the right side of the anchor may be near the book spine. But other embodiments are possible, including, but not limited to, positioning the ribbon vertically, near the middle of the anchor.

While preferred embodiments involve placing the anchor on the inside back cover of the book, in other embodiments it can be positioned on the inside front cover, or the outside of either cover or the spine, or on a book page.

Preferred slit-based embodiments have slits that are the same length (slightly wider than the ribbon) and which are positioned such that, when the anchor is in place in a book, a line drawn through the center of one slit to the center of the other would be parallel to the book's spine. But that does not have to be exactly the case. They may have different lengths and it may be that the line drawn through the slit centers would not be quite parallel, as long those they are close enough to the ideal of the preferred embodiment that ribbon movement is still essentially constrained to the vertical direction.

Additional modifications and improvements to the present invention may also be apparent to those skilled in the art. Thus the particular combinations of parts and steps described herein are intended to represent only certain embodiments of the present invention, and are not intended as limitations of alternate devices or methods within the spirit and scope of the invention.

The applicant claims:

1. A bookmark for indicating the current page in a book, comprising:
a ribbon having an upper portion and a lower portion, AND
a flexible, flat anchor having:
an adhering side at least partially covered with non-aggressive pressure-sensitive adhesive, such that the adhering side can be used to attach the bookmark to the book, and the bookmark adheres to the book until a user removes the bookmark, AND
a ribbon guide having a first open end and a second open end, the ribbon guide being configured such that the ribbon rests in the ribbon guide, the ribbon protrudes from the first open end and the second open end, and the ribbon can move substantially in only one dimension, the ribbon guide being further configured such that, when the bookmark is attached to the book, the user can alter the length of the upper portion of the ribbon by sliding the ribbon, and the ribbon guide being further configured to create friction between the ribbon guide and the ribbon, such that the user can alter the position of the ribbon but the ribbon's position does not substantially change without user manipulation.

2. The bookmark of claim 1 wherein the ribbon guide comprises at least one tunnel.

3. The bookmark of claim 1 wherein the ribbon guide comprises wherein the ribbon guide is comprised of two or more slits in the anchor and a means for separating the ribbon from the adhesive side.

4. The bookmark of claim 1 wherein at least one of the end of the lower portion of the ribbon and the end of the upper portion of the ribbon includes a ribbon stop.

5. The bookmark of claim 2 wherein at least one of the end of the lower portion of the ribbon and the end of the upper portion of the ribbon includes a ribbon stop.

6. The bookmark of claim 3 wherein at least one of the end of the lower portion of the ribbon and the end of the upper portion of the ribbon includes a ribbon stop.

7. A bookmark for indicating the current page in a book, comprising:
a ribbon having an upper portion and a lower portion, AND
a flexible, flat anchor having:
an adhering side at least partially covered with non-aggressive pressure-sensitive adhesive, such that the adhering side can be used to attach the bookmark to the book, and the bookmark adheres to the book until a user removes the bookmark, AND
means for guiding a ribbon having a first open end and a second open end, the means for guiding a ribbon being configured such that the ribbon rests in the means for guiding a ribbon, the ribbon protrudes from the first open end and the second open end, and the ribbon can move substantially in only one dimension, the means for guiding a ribbon being further configured such that, when the bookmark is attached to the book, the user can alter the length of the upper portion of the ribbon by sliding the ribbon, and the means for guiding a ribbon being further configured to create friction between the means for guiding a ribbon and the ribbon, such that the user can alter the position of the ribbon but the ribbon's position does not substantially change without user manipulation.

8. The bookmark of claim 7, wherein at least one of the end of the lower portion of the ribbon and the end of the upper portion of the ribbon includes a ribbon stop.

9. A method for marking a page within a book, using an apparatus comprising:
a ribbon having an upper portion and a lower portion, AND
a flexible, flat anchor comprising:
an adhering side at least partially covered with non-aggressive pressure-sensitive adhesive, AND
a ribbon guide having a first open end and a second open end, the ribbon guide being configured such that the ribbon rests in the ribbon guide, the ribbon protrudes from the first open end and the second open end, and the ribbon can move substantially in only one dimension, the ribbon guide being further configured such that, when the bookmark is attached to the book, a user can alter the length of the upper portion of the ribbon by sliding the ribbon, and the ribbon guide being further configured to create friction between the ribbon guide and the ribbon, such that the user can alter the position of the ribbon but the ribbon's position does not substantially change without user manipulation,
the method comprising:
a. positioning the anchor against a portion of a book near the top of the book and the spine of the book such that the adhering side of the anchor faces the portion of the book, and such that the distance between the ribbon guide and the spine of the book is not greater than the distance between the center of the anchor and the spine of the book,
b. applying pressure to the anchor so that it adheres to the portion of the book,
c. sliding the ribbon within the ribbon guide to alter the upper portion of the ribbon to a desired length,
d. draping the ribbon over the tops of one or more pages of the book,
e. draping the ribbon between two pages of the book, AND
f. closing the book.

10. A bookmark for indicating the current page in a book, comprising:
at least one ribbon, each of the ribbons having an upper portion and a lower portion, AND
a flexible, flat anchor having:
an adhering side at least partially covered with non-aggressive pressure-sensitive adhesive, such that the adhering side can be used to attach the bookmark to the book, and the bookmark adheres to the book until a user removes the bookmark, AND
at least one ribbon guide, each ribbon guide having a first open end and a second open end, each ribbon guide being configured such that one or more of the at least one ribbons rests in the at least one ribbon guide, each ribbon protrudes from the first open end and the second open end of the at least one ribbon guide, and the at least one ribbon can move substantially in only one dimension, the at least one ribbon guide being further configured such that, when the bookmark is attached to the inside cover of a book, the user can alter the length of the upper portion of the at least one ribbon by sliding the at least one ribbon, and the at least one ribbon guide being further configured to create friction between the at least one ribbon guide and the at least one ribbon, such that the user can alter the position of the at least one ribbon but the at least one ribbon's position does not substantially change without user manipulation.

11. The bookmark of claim 10, wherein at least one of the at least one ribbon guides comprises at least one tunnel.

12. The bookmark of claim 10, wherein at least one of the at least one ribbon guides comprises at least two slits in the anchor.

13. The bookmark of claim 10, wherein at least one of the lower portions of the plurality of ribbons includes a ribbon stop.
